(19) United States
(12) Patent Application Publication
(10) Pub. No.: US 2025/0130393 A1
(43) Pub. Date: Apr. 24, 2025

(54) LENS ASSEMBLY, LENS HOLDER, AND IMAGING APPARATUS

(71) Applicant: CANON KABUSHIKI KAISHA, Tokyo (JP)

(72) Inventors: KYOSUKE YOKOTANI, Kanagawa (JP); SHUSUKE TOBITA, Kanagawa (JP)

(21) Appl. No.: 18/921,512

(22) Filed: Oct. 21, 2024

(30) Foreign Application Priority Data
Oct. 24, 2023 (JP) 2023-182844
Jul. 19, 2024 (JP) 2024-115614

(51) Int. Cl. G02B 7/02; G02B 1/04; G02B 13/00

(52) U.S. Cl. CPC G02B 7/022; G02B 1/041; G02B 7/021; G02B 13/0035

(57) ABSTRACT

There is provided a lens assembly comprising a first resin lens, and a second resin lens superimposed on the first resin lens, wherein the first resin lens includes a first convex portion on a surface facing the second resin lens, wherein the second resin lens includes a first depressed portion on a surface facing the first resin lens into which the first convex portion is fittable, and wherein, even in a state where the first convex portion is fitted into any of first depressed portions, a gate position of the first resin lens and a gate position of the second resin lens are not overlapped with each other in a rotational direction around an optical axis.

### BACKGROUND

### Field

The present disclosure relates to a lens assembly, a lens holder, and an imaging apparatus.

### Description of the Related Art

Along with an increase in accuracy of an imaging device and advancement of a communication technology, an imaging apparatus is mounted on various apparatuses, and demand for a small lens is increasing. In particular, a lens assembly in which small lenses are superimposed is desirable in terms of space saving. However, when the lenses of the lens assembly are aligned with each other, sufficient alignment is not achieved in some cases due to a dimensional difference between the lenses.

International Publication No. 2015/111703 discusses a form in which three convex portions are provided on a first single lens and three groove portions are provided on a second single lens as positioning portions, and at least two of the positioning portions are different in inherent limitation direction.

### SUMMARY

According to an aspect of the present disclosure, a lens assembly comprises a first resin lens, and a second resin lens superimposed on the first resin lens, wherein the first resin lens includes a first convex portion on a surface facing the second resin lens, wherein the second resin lens includes a first depressed portion on a surface facing the first resin lens into which the first convex portion is fittable, and wherein, even in a state where the first convex portion is fitted into any of first depressed portions, a gate position of the first resin lens and a gate position of the second resin lens are not overlapped with each other in a rotational direction around an optical axis.

According to another aspect of the present disclosure, a lens assembly comprises a first resin lens, a second resin lens superimposed on the first resin lens, and a third resin lens superimposed on the second resin lens on a side opposite to the first resin lens, wherein the first resin lens includes a first convex portion on a surface facing the second resin lens, wherein the second resin lens includes a first depressed portion on a surface facing the first resin lens into which the first convex portion is fittable, wherein a number of first depressed portions is greater than a number of first convex portions, wherein the second resin lens includes a second convex portion on a surface facing the third resin lens, wherein the third resin lens includes a second depressed portion on a surface facing the second resin lens into which the second convex portion is fittable, and wherein a number of second depressed portions is greater than a number of second convex portions.

Further features of the present disclosure will become apparent from the following description of exemplary embodiments with reference to the attached drawings.

### BRIEF DESCRIPTION OF THE DRAWINGS

FIG. 1 is a perspective view of a lens assembly according to a first exemplary embodiment.

FIG. 2 is a top view of the lens assembly according to the first exemplary embodiment.

FIG. 3 is a cross-sectional view of the lens assembly taken along line A-A in FIG. 2.

FIG. 4 is a top view of a first lens.

FIG. 5 is a top view of a second lens.

FIG. 6 is a top view of a third lens.

FIG. 7 is a top view of a lens assembly according to a second exemplary embodiment.

FIG. 8 is a diagram illustrating multi-cavity molding for a plurality of lenses.

FIG. 9 is a perspective view of a lens assembly according to a first comparative example.

FIG. 10 is a top view of the lens assembly according to the first comparative example.

FIG. 11 is a cross-sectional view taken along line B-B in FIG. 10.

FIG. 12 is a top view of a second lens according to a second comparative example.

FIG. 13 is a top view of a third lens according to the second comparative example.

FIG. 14 is a diagram illustrating an imaging apparatus as an example of an apparatus using the lens assembly according to any of the exemplary embodiments.

FIG. 15 is a perspective view of a lens assembly according to a fourth exemplary embodiment.

FIG. 16 is a top view of a first lens.

FIG. 17 is a top view of a second lens.

FIG. 18 is a top view of a third lens.

### DESCRIPTION OF THE EMBODIMENTS

Some exemplary embodiments of the present disclosure are described below with reference to the drawings. Note that forms described below are exemplary embodiments of the disclosure, and are not limited thereto. Common components are described with cross-reference to a plurality of drawings, and description of components denoted by common reference numerals is appropriately omitted. Different items having the same name can be distinguished from each other by allocating ordinal numbers, such as a first item, a second item, and the like.

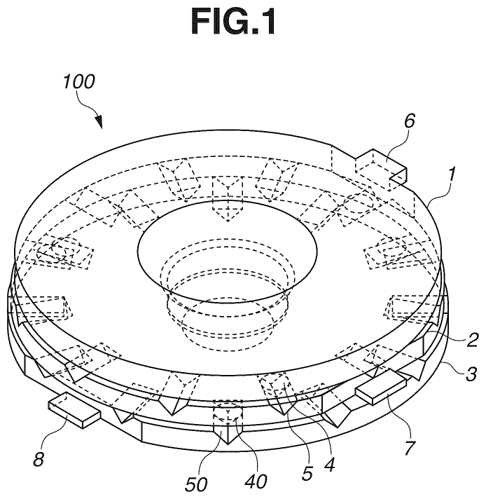

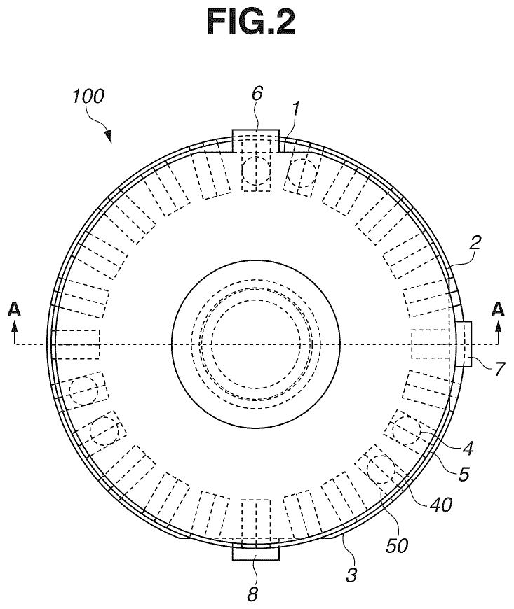

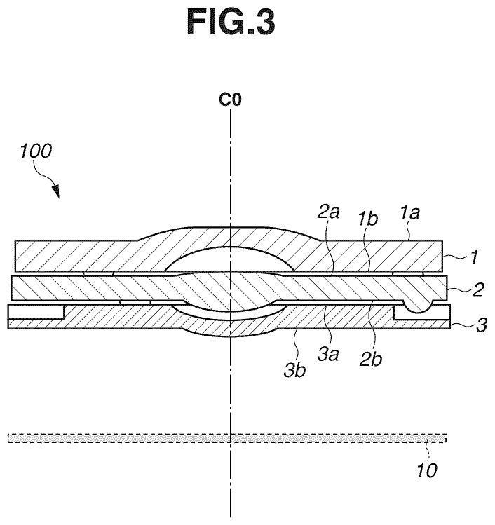

A lens assembly 100 according to a first exemplary embodiment is described with reference to FIG. 1 to FIG. 3. FIG. 1 is a perspective view of the lens assembly 100. FIG. 2 is a top view of the lens assembly 100. FIG. 3 is a cross-sectional view of the lens assembly 100 taken along line A-A in FIG. 2. The lens assembly 100 is assembled by superimposing a lens 1 (first lens), a lens 2 (second lens), and a lens 3 (third lens) disposed on the lens 2 on a side opposite to the lens 1.

The lens 1 is disposed on an object side, and the lens 3 is disposed on an imaging device 10 side. The lens assembly 100 is not necessarily a lens assembly in which three lenses are assembled, and may be a lens assembly in which two or more lenses are superimposed.

In a resin lens manufactured by injection molding, in particular, by injection molding of a resin, astigmatism based on a direction of a gate that is an inlet for causing a resin to flow into a mold from an injection molding machine may occur. In a case where a plurality of lenses each having astigmatism based on a gate direction is assembled, the lenses are superimposed in a lens orthogonal direction and are assembled, which makes it possible to cancel the astigmatism as a whole of the lens assembly and to enhance optical performance.

As illustrated in FIG. 3, the lens 1 includes a surface la on the object side, and a surface 1b on the imaging device 10 side. The lens 2 includes a surface 2a on the object side, and a surface 2b on the imaging device 10 side. Likewise, the lens 3 includes a surface 3a on the object side, and a surface 3b on the imaging device 10 side. Each of the lens 1 and the lens 3 is, for example, a lens in which a thickness at a center is less than a thickness at an outer periphery (flange part), and the lens 2 is, for example, a lens in which the thickness at the center is greater than the thickness at the outer periphery.

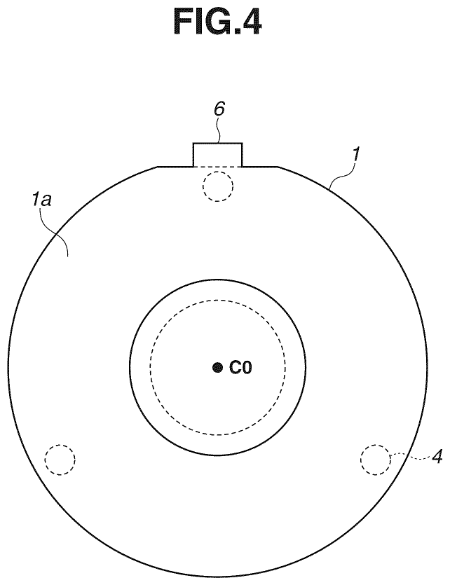

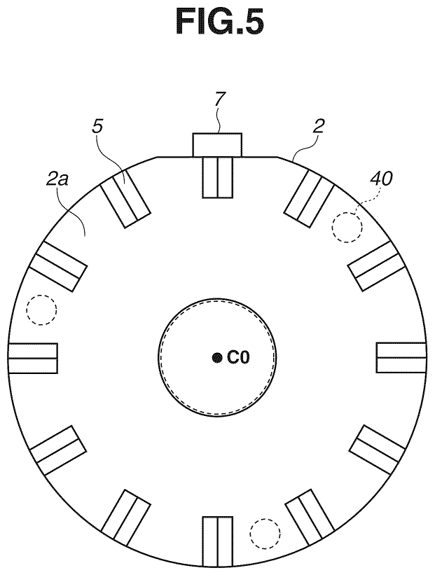

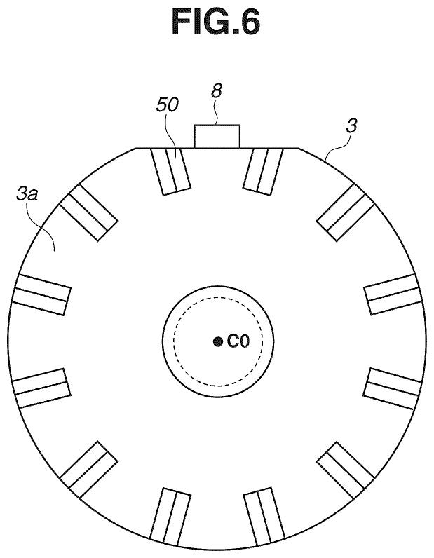

Next, the lens 1, the lens 2, and the lens 3 are described in detail with reference to FIG. 4 to FIG. 6. FIG. 4 is a top view of the lens 1, FIG. 5 is a top view of the lens 2, and FIG. 6 is a top view of the lens 3. The lens 1, the lens 2, and the lens 3 respectively include a gate 6, a gate 7, and a gate 8 at positions where portions of gates used in injection molding are chamfered. The gates of the vertically adjacent lenses assembled as the lens assembly 100 are disposed at positions shifted 90 degrees around an optical axis C0. The gate of a lens is an inlet through which a mold is filled with a resin in order to mold a resin lens by injection molding. A part of the gate may be cut or polished after molding of the lens. Such a portion is also referred to as the gate (gate position) according to the present exemplary embodiment.

A plurality of convex portions 4 is disposed on the surface 1b of the lens 1. In FIG. 4, three convex portions 4 are illustrated; however, the number of convex portions 4 may be one or two or more. In a case where the plurality of convex portions 4 is provided, the plurality of convex portions 4 is disposed on one circle with the optical axis C0 as a center. An angle formed by adjacent two line segments each connecting one of the convex portions 4 and the optical axis C0 may have a value obtained by dividing 360 degrees by the number of convex portions 4. However, the angle is not required to have a value obtained by precisely dividing 360 degrees by the number of convex portions 4, and may have a value within a range of ±10 degrees thereof. The convex portions 4 may be disposed near the outer periphery of the lens 1. More specifically, the convex portions 4 may be disposed on the outer periphery side of the lens 1 relative to a middle point between the optical axis C0 and the outer periphery of the lens 1. In particular, as illustrated in FIG. 4, the convex portions 4 are disposed on the flange part of the lens 1.

A plurality of grooves 5 is disposed on the surface 2a of the lens 1. In FIG. 5, a case where 12 grooves 5 are provided is illustrated; however, it is sufficient that the number of grooves 5 is greater than at least the number of convex portions 4. In particular, the number of grooves 5 may be an integral multiple of the number of convex portions 4. Each of the convex portions 4 may have a spherical surface, but may have a cone shape, a square pyramid shape, or the like. Each of the grooves 5 has a shape to be fitted into each of the convex portions 4, and may be, for example, a V-shaped groove, but may be a U-shaped groove or a rectangular groove. As illustrated in the drawings, surface shapes of the convex portions 4 and the grooves 5 may be different from each other. By the convex portions 4 being fitted into the grooves 5, the lens 1 and the lens 2 can be positioned. Further, since the number of grooves 5 in the lens 2 is greater than the number of convex portions 4, a degree of freedom in positioning of the lens 1 and the lens 2 is improved, and positioning accuracy can be improved. The number of options in positioning of the lens 1 and the lens 2 is equal to the number of grooves 5. Therefore, in the case illustrated in FIG. 5, the number of options in positioning is 12.

In the lens assembly 100 according to the present exemplary embodiment, the number of grooves 5 is greater than the number of convex portions 4. Therefore, in positioning of the lens 1 and the lens 2, the grooves 5 into which the convex portions 4 are fitted and the grooves 5 into which the convex portions 4 are not fitted are present. Desired positioning can be performed by changing the grooves 5 into which the convex portions 4 are fitted and the grooves 5 into which the convex portions 4 are not fitted.

The plurality of grooves 5 is disposed on one circle with the optical axis C0 as a center. The convex portions 4 may be provided on the same circle. In addition, an angle formed by adjacent two line segments each connecting one of the grooves 5 and the optical axis C0 may have a value obtained by dividing 360 degrees by the number of grooves 5. However, the angle is not required to have a value obtained by precisely dividing 360 degrees by the number of grooves 5, and may have a value within a range of ±10 degrees thereof.

The grooves 5 may be disposed near the outer periphery of the lens 2. More specifically, the grooves 5 may be disposed on the outer periphery side of the lens 2 relative to a middle point between the optical axis C0 and the outer periphery of the lens 2.

In particular, as illustrated in FIG. 5, the grooves 5 are provided on the flange part of the lens 2.

A plurality of convex portions 40 (second convex portions) is disposed on the surface 2b of the lens 2. In FIG. 5, three convex portions 40 are illustrated; however, the number of convex portions 40 may be one or two or more. In a case where the plurality of convex portions 40 is provided, the plurality of convex portions 40 is disposed on one circle with the optical axis C0 as a center. In addition, an angle formed by adjacent two line segments each connecting one of the convex portions 40 and the optical axis C0 may have a value obtained by dividing 360 degrees by the number of convex portions 40. However, the angle is not required to have a value obtained by precisely dividing 360 degrees by the number of convex portions 40, and may have a value within a range of ±10 degrees thereof. The convex portions 40 may be disposed near the outer periphery of the lens 2. More specifically, the convex portions 40 may be disposed on the outer periphery side of the lens 2 relative to the middle point between the optical axis C0 and the outer periphery of the lens 2. In particular, as illustrated in FIG. 5, the convex portions 40 are disposed on the flange part of the lens 2.

A plurality of grooves 50 (second concave portions) is disposed on the surface 3a of the lens 3. In FIG. 6, 12 grooves 50 are illustrated; however, it is sufficient that the number of grooves 50 is greater than at least the number of convex portions 40. In particular, the number of grooves 50 is an integral multiple of the number of convex portions 40. Each of the grooves 50 has a shape into which each of the convex portions 40 is fitted, and may be, for example, a V-shaped groove, but may be a U-shaped groove or a rectangular groove. By the convex portions 40 being fitted into the grooves 50, the lens 2 and the lens 3 can be positioned. Further, since the number of grooves 50 in the lens 3 is greater than the number of convex portions 40, a degree of freedom in positioning of the lens 2 and the lens 3 is improved, and positioning accuracy can be improved. The number of options in positioning of the lens 2 and the lens 3 is equal to the number of grooves 50. Therefore, in the case illustrated in FIG. 6, the number of options in positioning is 12.

In the lens assembly 100 according to the present exemplary embodiment, the number of grooves 50 is greater than the number of convex portions 40. Therefore, in positioning of the lens 2 and the lens 3, the grooves 50 into which the convex portions 40 are fitted and the grooves 50 into which the convex portions 40 are not fitted are present. Desired positioning can be performed by changing the grooves 50 into which the convex portions 40 are fitted and the grooves 50 into which the convex portions 40 are not fitted.

The plurality of grooves 50 is disposed on one circle with the optical axis C0 as a center. The convex portions 40 may be provided on the same circle. In addition, an angle formed by adjacent two line segments each connecting one of the grooves 50 and the optical axis C0 may have a value obtained by dividing 360 degrees by the number of grooves 50. However, the angle is not required to have a value obtained by precisely dividing 360 degrees by the number of grooves 50, and may have a value within a range of ±10 degrees thereof.

The grooves 50 may be disposed near the outer periphery of the lens 3. More specifically, the grooves 50 may be disposed on the outer periphery side of the lens 3 relative to a middle point between the optical axis C0 and the outer periphery of the lens 3. In particular, as illustrated in FIG. 6, the grooves 50 are disposed on the flange part of the lens 3.

As illustrated in FIG. 5, in the lens 2, the gate 7 is disposed at a position of the same phase as one of the grooves 5 in a rotational direction around the optical axis C0, namely, at a position coincident with a position of one of the grooves 5 in an optical axis direction. As illustrated in FIG. 6, in the lens 3, the gate 8 is disposed at a position of a phase between the grooves 50 in a rotational direction around the optical axis C0, namely, at a position not coincident with a position of any of the grooves 50 in the optical axis direction. In other words, the grooves 5 of the lens 2 and the grooves 50 of the lens 3 vertically superimposed are disposed at different positions (phases) in the rotational direction around the optical axis C0.

In the lens 3 in which the thickness at the center is less than the thickness at the outer periphery, flow resistance of the resin flowing from the gate 8 toward the lens center is increased. A flow of the resin at the lens center is lower than a flow of the resin at the outer periphery, pressure distribution in a pressure keeping process is increased, and astigmatism occurs. When the gate 8 is disposed at a position of the phase between the grooves 50 as in the lens 3, it is possible to cause the resin to flow toward the lens center and to reduce the astigmatism that occurs.

In the lens 2 in which the thickness at the center is greater than the thickness at the outer periphery, flow resistance of the resin flowing from the gate 7 toward the lens center is reduced. A flow of the resin at the lens center is higher than a flow of the resin at the outer periphery, and astigmatism occurs. When the gate 7 is disposed at a position of the same phase as one of the grooves 5 as in the lens 2, it is possible to increase the resin resistance toward the lens center and to reduce the astigmatism that occurs.

In the present exemplary embodiment, the lens assembly 100 in which the lens 1, the lens 2, and the lens 3 are stacked is described; however, the lens assembly 100 may include only the lens 1 and the lens 2. Alternatively, the lens assembly 100 may include the lens 2 and the lens 3 stacked on each other. The lens assembly 100 may include any lenses stacked on each other in any order.

As described above, in the lens assembly 100, the convex portions and the grooves in number greater than the number of the convex portions are disposed on the surfaces of the lenses facing each other, which makes it possible to improve positioning accuracy.

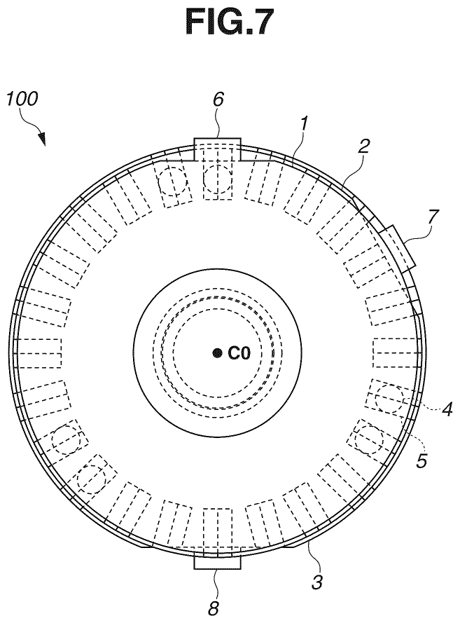

The lens assembly 100 according to a second exemplary embodiment is described with reference to FIG. 7. FIG. 7 is a top view of the lens assembly 100 according to the second exemplary embodiment.

The lens assembly 100 according to the present exemplary embodiment is different from the lens assembly 100 according to the first exemplary embodiment in that assembling angles are changed. More specifically, the gate 7 of the lens 2 is disposed at a position rotated 60 degrees in the rotational direction around the optical axis C0 from the gate 6 of the lens 1. Further, the gate 8 of the lens 3 is provided at a position rotated 120 degrees in the rotational direction around the optical axis C0 from the gate 7 of the lens 2.

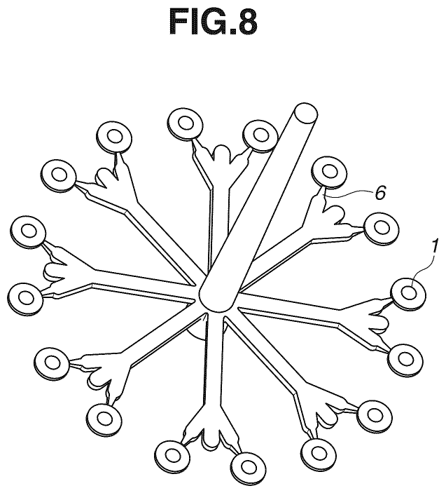

In a case where astigmatism occurs in a direction different from the gate direction due to various factors in injection molding, use of such arrangement enables adjustment of assembling rotation angles as in the present exemplary embodiment, based on a direction of the astigmatism. For example, in a case where lenses are molded by multi-cavity molding with a cavity layout as illustrated in FIG. 8 and a direction of astigmatism is changed depending on each cavity, a combination of a cavity number of each lens and an assembling rotation angle may be defined, which makes it possible to facilitate management.

### EXAMPLE

Next, the present exemplary embodiments are described in more detail by using an example and comparative examples; however, the present exemplary embodiments are not to be limited by the following example.

In the example, the lens assembly 100 illustrated in FIG. 1 to FIG. 6 was fabricated. The lenses of the lens assembly 100 were fabricated by resin molding using a multi-cavity mold as illustrated in FIG. 8.

The astigmatism of the surface 3a of the lens 3 was reduced by an effect of the phases of the gate 8 and the grooves 50.

The lenses according to the example were stacked and assembled by a robot having an assembling angle adjustment capability of ±1.5 degrees. Variation in optical axis rotation positions of the lenses was determined by shape accuracy of the convex portions 40 and the grooves 50, and the variation was ±1degree or less.

### First Comparative Example

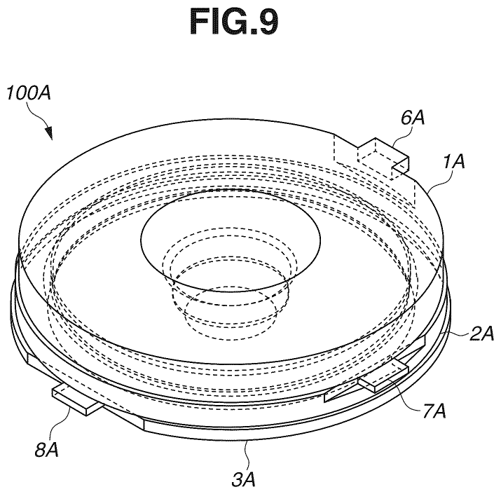

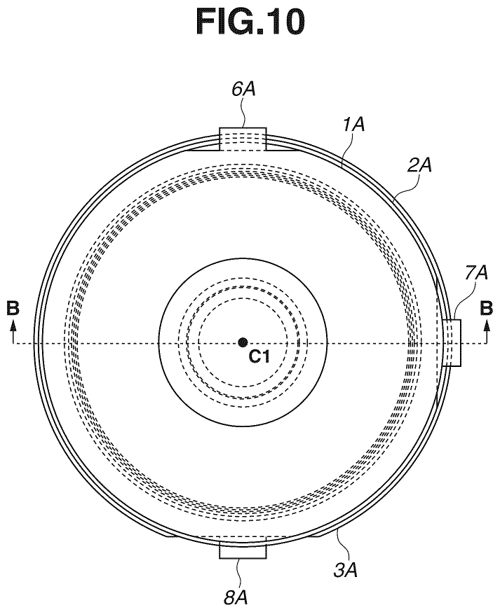

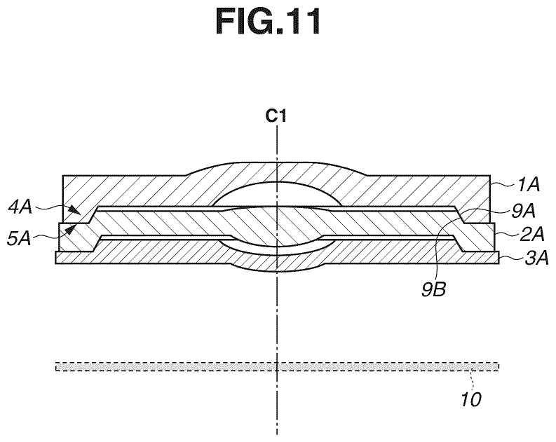

FIG. 9 is a perspective view of a lens assembly 100A in which three lenses (lens 1A, lens 2A, and lens 3A) are superimposed and assembled according to a first comparative example, FIG. 10 is a top view thereof, and FIG. 11 is a cross-sectional view taken along line B-B in FIG. 10.

The lens assembly 100A includes an imaging device 10A. The lens 1A is disposed on the object side, and the lens 3A is disposed on the imaging device 10A side.

The above-described assembly diagram focuses on a partial process in a manufacturing process of the lens assembly 100A, and accessory parts, such as a lens barrel, a spacer, and a diaphragm, are omitted. A contact shape of each of the lenses is different from the contact shape of each of the lenses according to the example.

A tapered shape 9A with an optical axis C1 as the center is formed on a surface of the lens 1A on the imaging device 10A side. A tapered shape 9B with the optical axis C1 as the center is formed on a surface of the lens 2A on the object side.

The tapered shape 9A and the tapered shape 9B are formed over an entire circumference of the lens assembly 100A and are configured to be fitted together. In other words, one convex portion 4A is formed on the lens 1A, and one groove 5A is formed on the lens 2A.

When the tapered shapes of the lens 1A and the lens 2A come into contact with each other, relative positions of the lenses in a radial direction can be accurately managed, but positional accuracy in the rotational direction around the optical axis C1 depends on the assembling angle adjustment capability of the robot.

Likewise, when the tapered shapes of the lens 2A and the lens 3A come into contact with each other, relative positions of the lens 2A and the lens 3A in the radial direction can be accurately managed, but positional accuracy in the rotational direction around the optical axis C1 depends on the assembling angle adjustment capability of the robot.

The lenses according to the first comparative example were stacked and assembled by the robot having the assembling angle adjustment capability of ±1.5 degrees. Variation in optical axis rotation positions of the lenses at that time was ±3 degrees, and variation in assembling quality was large as compared with the example.

### Second Comparative Example

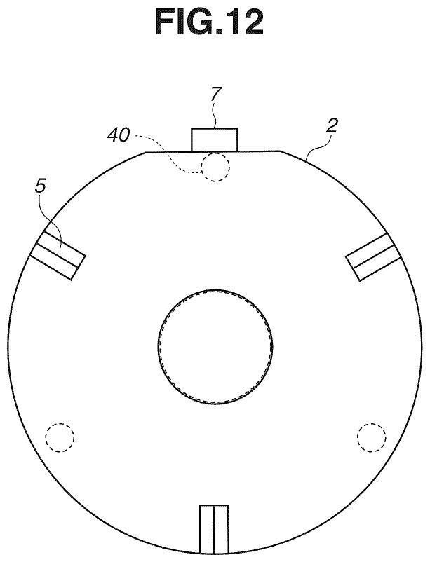

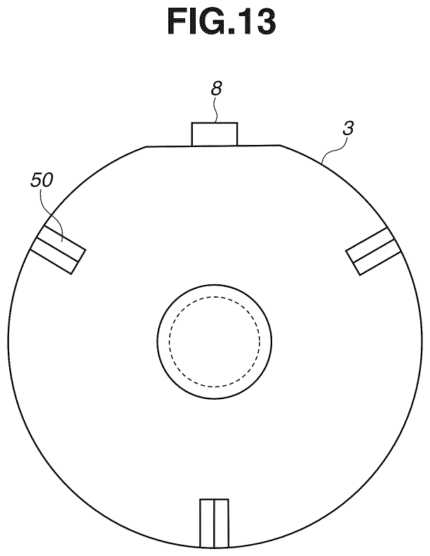

FIG. 12 is a top view of the lens 2A according to a second comparative example, and FIG. 13 is a top view of the lens 3A according to the second comparative example. In the second comparative example, unlike the example, the number of grooves 5A of the lens 2A is three that is equal to the number of convex portions 4A of the lens 1A. Likewise, the number of grooves 50A of the lens 3A is three that is equal to the number of convex portions 40A of the lens 2A. Other configurations are similar to the configuration according to the example.

The lenses according to the second comparative example were stacked and assembled by the robot having the assembling angle adjustment capability of ±1.5 degrees. Variation in optical axis rotation positions of the lenses at that time was ±1 degree or less, which was a good level. However, since three grooves 5A and three grooves 50A were provided, the number of possible options in positioning of the lens assembly 100A was three, and it was difficult to adjust the lenses to desired positions.

In the example, since the number of grooves 5 is greater than the number of convex portions 4, the lenses can be positioned with high accuracy as compared with the first and second comparative examples.

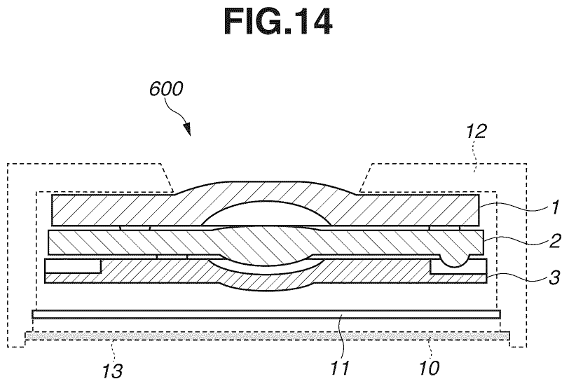

Next, as an example of an electronic apparatus on which the lens assembly 100 described in the first and second exemplary embodiments is mountable, an imaging apparatus 600 according to a third exemplary embodiment is described with reference to FIG. 14.

The imaging apparatus 600 includes a lens assembly including three lenses (lens 1, lens 2, and lens 3), the imaging device 10, a filter 11, a holder 12, and an external circuit 13.

The three lenses (lens 1, lens 2, and lens 3) are superimposed and assembled. The lenses are arranged such that the lens 1 is disposed on the object side, and the lens 3 is disposed on the imaging device 10 side.

The imaging device 10 detects an object image formed by the three lenses (lens 1, lens 2, and lens 3), converts detected light into charges, and outputs the charges to the external circuit 13.

The filter 11 is provided between the lens 3 and the imaging device 10. The filter 11 is, for example, an infrared cut filter, and has a function of reflecting infrared rays.

The holder 12 is a member for assembling and holding the three lenses (lens 1, lens 2, and lens 3), the imaging device 10, and the filter 11.

The lens assembly including the three lenses may be housed and disposed inside a lens barrel, and the imaging device 10 receiving light having passed through the lens barrel is disposed in a housing connected to the lens barrel.

Next, a form of the lens assembly 100 different from the form according to the first exemplary embodiment is described. In a fourth exemplary embodiment, differences from the first exemplary embodiment are mainly described, and description of similar contents is omitted.

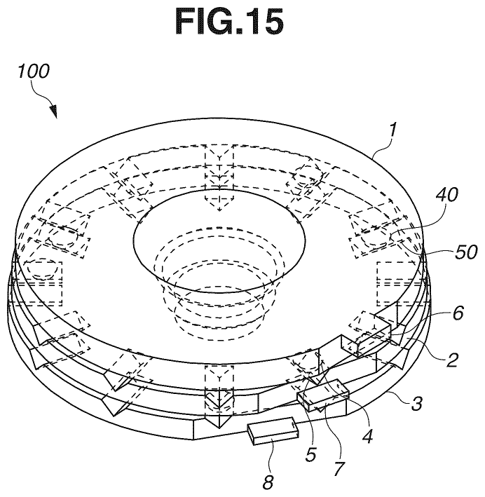

The lens assembly 100 according to the fourth exemplary embodiment is different in positions of the grooves 5 of the lens 2 and the grooves 50 of the lens 3 from the lens assembly 100 according to the first exemplary embodiment. FIG. 15 is a perspective view illustrating an example of the lens assembly 100 in which three lenses are assembled.

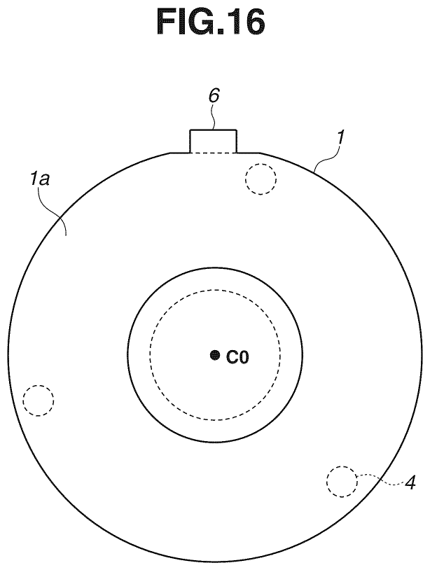

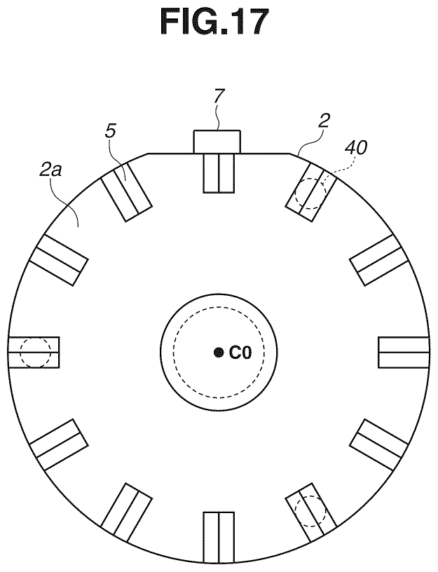

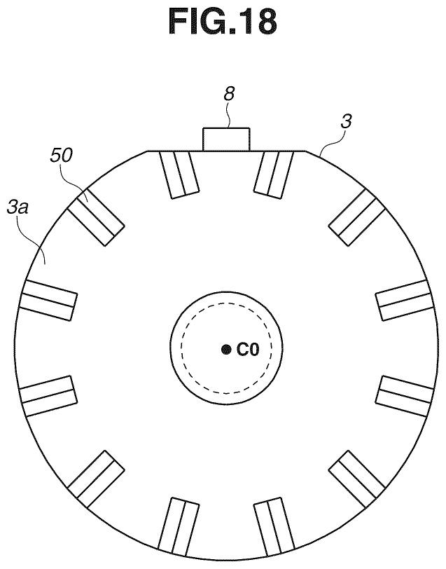

The lens 1, the lens 2, and the lens 3 are described in detail with reference to FIG. 16 to FIG. 18. FIG. 16 is a top view of the lens 1, FIG. 17 is a top view of the lens 2, and FIG. 18 is a top view of the lens 3.

The lens 1, the lens 2, and the lens 3 respectively include the gate 6, the gate 7, and the gate 8 at positions where portions of gates used in injection molding are chamfered. The gates of the vertically adjacent lenses assembled as the lens assembly 100 are disposed so as not to be overlapped with each other in a rotational direction around an optical axis. More specifically, the gate positions can be adjusted by adjusting positional relationship between the grooves and the convex portions of the lenses vertically assembled as the lens assembly.

In the example illustrated in FIG. 15, the grooves and the convex portions of the vertically assembled lenses are arranged so as to be shifted to positions rotated at least 15 degrees or more around the optical axis C0.

The plurality of convex portions 4 is disposed on the surface 1b of the lens 1. In FIG. 16, three convex portions 4 are illustrated; however, the number of convex portions 4 may be one or two or more. In the case where the plurality of convex portions 4 is provided, the plurality of convex portions 4 is disposed on one circle with the optical axis C0 as a center. An angle formed by adjacent two line segments each connecting one of the convex portions 4 and the optical axis C0 may have a value obtained by dividing 360 degrees by the number of convex portions 4. However, the angle is not required to have a value obtained by precisely dividing 360 degrees by the number of convex portions 4, and may have a value within a range of ±10 degrees.

The plurality of grooves 5 is disposed on the surface 2a of the lens 2. In FIG. 17, a case where 12 grooves 5 are provided is illustrated.

In the lens assembly 100 according to the present exemplary embodiment, the number of grooves 5 is greater than the number of convex portions 4. Therefore, in positioning of the lens 1 and the lens 2, the grooves 5 into which the convex portions 4 are fitted and the grooves 5 into which the convex portions 4 are not fitted are present. Desired positioning can be performed by changing the grooves 5 into which the convex portions 4 are fitted and the grooves 5 into which the convex portions 4 are not fitted.

In the lens 1 and the lens 2, the convex portions 4 and the grooves 5 are disposed such that the gate 6 of the lens 1 and the gate 7 of the lens 2 are not overlapped with each other in the rotational direction around the optical axis C0 even in a state where any of the convex portions 4 and any of the grooves 5 are fitted together.

The plurality of convex portions 40 (second convex portions) is disposed on the surface 2b of the lens 2. In FIG. 17, three convex portions 40 are illustrated; however, the number of convex portions 40 may be one or two or more.

The plurality of grooves 50 (second concave portions) is disposed on the surface 3a of the lens 3. In FIG. 18, 12 grooves 50 are illustrated; however, it is sufficient that the number of grooves 50 is greater than at least the number of convex portions 40.

In the lens assembly 100 according to the present exemplary embodiment, the number of grooves 50 is greater than the number of convex portions 40. Therefore, in positioning of the lens 2 and the lens 3, the grooves 50 into which the convex portions 40 are fitted and the grooves 50 into which the convex portions 40 are fitted are present. Desired positioning can be performed by changing the grooves 50 into which the convex portions 40 are fitted and the grooves 50 into which the convex portions 40 are not fitted.

Further, in the lens 2 and the lens 3, the convex portions 40 and the grooves 50 are disposed such that the gate 7 of the lens 2 and the gate 8 of the lens 3 are not overlapped with each other in the rotational direction around the optical axis C0 even in a state where any of the convex portions 40 and any of the grooves 50 are fitted together.

As described above, the gates of the lenses vertically positioned when the lenses are assembled as the lens assembly 100 are disposed so as not to overlap each other in the rotational direction around the optical axis C0, which makes it possible to reduce influence of distortion occurring on each of the lenses by injection molding.

In a case where more lenses are assembled as the lens assembly, the positions of gates may be coincident with each other among some of the lenses, and it is sufficient that the gates are disposed so as not to overlap each other among lenses subjected to a large influence of distortion.

The exemplary embodiments described above can be appropriately changed without departing from the technical idea.

For example, the plurality of exemplary embodiments may be combined. Further, items according to at least one of the exemplary embodiments may be partially deleted or replaced.

Further, a new item may be added to at least one of the exemplary embodiments. The disclosed contents of the present specification are not limited to items explicitly described in the present specification, and include all items that can be understood from the present specification and the drawings attached to the present specification.

The disclosed contents of the present specification include a complementary set of individual concepts described in the present specification. For example, when there is a description that “A is greater than B” in the present specification, it can be said that the present specification discloses a description that “A is not greater than B” even if the description that “A is not greater than B” is omitted. This is because the description that “A is greater than B” is based on an assumption that a case where “A is not greater than B” is considered.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-182844, filed Oct. 24, 2023, and No. 2024-115614, filed Jul. 19, 2024, which are hereby incorporated by reference herein in their entirety.

What is claimed is:

1. A lens assembly comprising:
a first resin lens; and
a second resin lens superimposed on the first resin lens,
wherein the first resin lens includes a first convex portion on a surface facing the second resin lens,
wherein the second resin lens includes a first depressed portion on a surface facing the first resin lens into which the first convex portion is fittable, and
wherein, even in a state where the first convex portion is fitted into any of first depressed portions, a gate position of the first resin lens and a gate position of the second resin lens are not overlapped with each other in a rotational direction around an optical axis.

2. The lens assembly according to claim 1, wherein, even in the state where the first convex portion is fitted into any of the first depressed portions, the gate position of the second resin lens is a position rotated 15 degrees or more from the gate position of the first resin lens in the rotational direction around the optical axis.

3. The lens assembly according to claim 1, wherein a plurality of first convex portions is provided.

4. The lens assembly according to claim 1, wherein a number of first depressed portions is an integral multiple of a number of first convex portions.

5. The lens assembly according to claim 1, wherein a surface shape of the first convex portion is different from a surface shape of the first depressed portion.

6. The lens assembly according to claim 1, wherein the first convex portion has a spherical surface, and the first depressed portion has a V-shape or a U-shape.

7. The lens assembly according to claim 1, wherein, when a direction in which the first resin lens and the second resin lens are superimposed is defined as an axis, the first depressed portion has a rectangular shape extending in a radial direction of the axis.

8. The lens assembly according to claim 1, wherein three first depressed portions are provided.

9. The lens assembly according to claim 1, wherein a direction in which the first resin lens and the second resin lens are superimposed is a direction in which an optical axis of the lens assembly extends.

10. The lens assembly according to claim 1,
wherein the second resin lens is a lens in which a thickness at a center of the lens is greater than a thickness at an outer periphery of the lens, and
wherein the gate position of the second resin lens is disposed not to be coincident with any of the first depressed portions in a rotational direction around an optical axis of the lens assembly.

11. The lens assembly according to claim 1, further comprising a third resin lens superimposed on the second resin lens on a side opposite to the first resin lens,
wherein the second resin lens includes a second convex portion on a surface facing the third resin lens, and
wherein the third resin lens includes a second depressed portion into which the second convex portion is fittable on a surface facing the second resin lens.

12. The lens assembly according to claim 11, wherein, even in a state where the first convex portion is fitted into any of the first depressed portions and the second convex portion is fitted into any of second depressed portions, the gate position of the first resin lens, the gate position of the second resin lens, and a gate position of the third resin lens are not overlapped with each other in the rotational direction around the optical axis.

13. The lens assembly according to claim 12, wherein, even in the state where the first convex portion is fitted into any of the first depressed portions and the second convex portion is fitted into any of the second depressed portions, the gate position of the first resin lens, the gate position of the second resin lens, and the gate position of the third resin lens are positions rotated 15 degrees or more from each other in the rotational direction around the optical axis.

14. The lens assembly according to claim 12, wherein a number of first convex portions is equal to a number of second convex portions.

15. The lens assembly according to claim 11,
wherein the third resin lens is a lens in which a thickness at a center of the lens is less than a thickness at an outer periphery of the lens, and
wherein a gate position of the third resin lens is disposed at a position between the second depressed portion and a depressed portion adjacent to the second depressed portion in a rotational direction around an optical axis of the lens assembly.

16. A lens assembly comprising:
a first resin lens;
a second resin lens superimposed on the first resin lens; and
a third resin lens superimposed on the second resin lens on a side opposite to the first resin lens,
wherein the first resin lens includes a first convex portion on a surface facing the second resin lens,
wherein the second resin lens includes a first depressed portion on a surface facing the first resin lens into which the first convex portion is fittable,
wherein a number of first depressed portions is greater than a number of first convex portions,
wherein the second resin lens includes a second convex portion on a surface facing the third resin lens,
wherein the third resin lens includes a second depressed portion on a surface facing the second resin lens into which the second convex portion is fittable, and
wherein a number of second depressed portions is greater than a number of second convex portions.

17. The lens assembly according to claim 16,
wherein the second resin lens is a lens in which a thickness at a center of the lens is greater than a thickness at an outer periphery of the lens,
wherein a gate position of the second resin lens is disposed not to be coincident with the first depressed portion in a rotational direction around an optical axis of the lens assembly,
wherein the third resin lens is a lens in which a thickness at a center of the lens is less than a thickness at an outer periphery of the lens, and
wherein a gate position of the third resin lens is disposed at a position between the second depressed portion and a depressed portion adjacent to the second depressed portion in the rotational direction around the optical axis of the lens assembly.

18. A lens holder comprising the lens assembly according to claim 1.

19. An imaging apparatus comprising:
the lens holder according to claim 18; and
an imaging device configured to receive light having passed through the lens holder.

20. The imaging apparatus according to claim 19, wherein the imaging device is disposed inside the lens holder.
